(19) United States
(12) Patent Application Publication
(10) Pub. No.: US 2026/0192799 A1
(43) Pub. Date: Jul. 9, 2026

(54) DEVICE FOR DETERMINING THE OVERALL HEIGHT OF A VEHICLE WITH A TRANSPORT ELEMENT MOUNTED ON THE VEHICLE, AND VEHICLE HAVING A DEVICE FOR DETERMINING THE OVERALL HEIGHT OF A VEHICLE

(71) Applicant: HELLA GmbH & Co. KGaA, Lippstadt (DE)

(72) Inventors: Sven LIEBAU, Berlin (DE); Juergen MAYNTZ, Berlin (DE)

(73) Assignee: HELLA GmbH & Co. KGaA, Lippstadt (DE)

(21) Appl. No.: 19/555,189

(22) Filed: Mar. 3, 2026

Related U.S. Application Data
(63) Continuation of application No. PCT/EP2024/073869, filed on Aug. 27, 2024.

(30) Foreign Application Priority Data
Sep. 4, 2023 (DE) 10 2023 123 740.3

(51) Int. Cl. B60W 30/09; B60W 10/18; B60W 10/20; B60W 30/095; B60W 50/14; B60W 60/00; G01S 5/14; G01S 13/02; G01S 13/08

(52) U.S. Cl. CPC B60W 30/09; B60W 10/18; B60W 10/20; B60W 30/0956; B60W 50/14; B60W 60/0015; G01S 5/14; G01S 13/0209; G01S 13/08; B60W 2530/00

(57) ABSTRACT

Device for determining the overall height of a vehicle with a transport element arranged on the vehicle. A sensing device senses the transport element. An evaluation unit that is connectable to the sensing device and is designed such that an overall height of the vehicle with the mounted transport element can be ascertained from the signals of the sensing device. The sensing device has at least one UWB sensor arranged unambiguously in a vehicle coordinate system and a UWB tag that can be coupled to the UWB sensor. The UWB sensor is arranged on the vehicle and the UWB tag is arranged on the transport element. The evaluation unit is designed such that the position of the UWB tag in the vehicle coordinate system is ascertained via the coupling of the UWB tag to the UWB sensor and, based thereon, the overall height of the vehicle is ascertained.

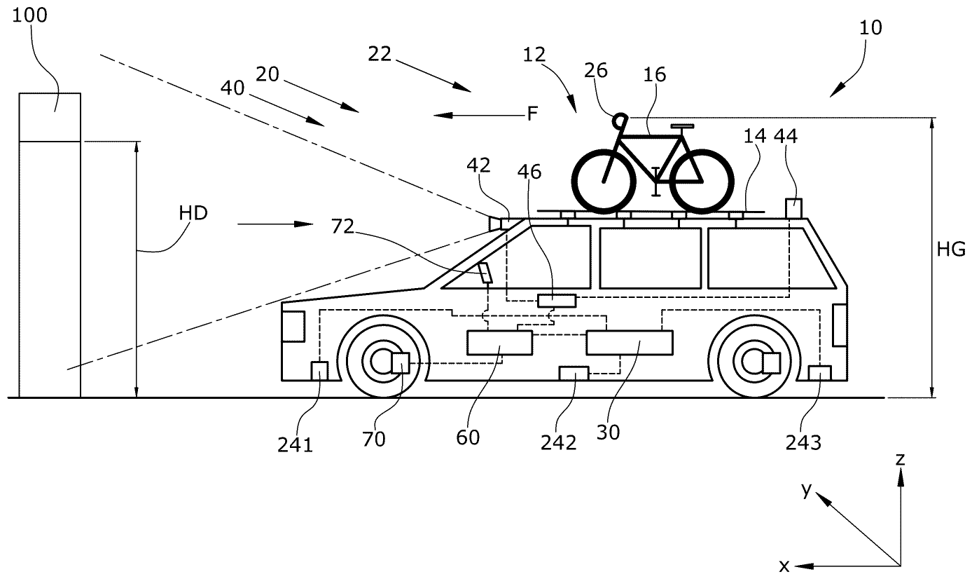

This nonprovisional application is a continuation of International Application No. PCT/EP2024/073869, which was filed on Aug. 27, 2024, and which claims priority to German Patent Application No. 10 2023 123 740.3, which was filed in Germany on Sep. 4, 2023, and which are both herein incorporated by reference.

### BACKGROUND OF THE INVENTION

### Field of the Invention

The invention relates to a device for determining the overall height of a vehicle with a transport element arranged, in particular mounted, on the vehicle, as well as to a vehicle having a device for determining the overall height of a vehicle.

### Description of the Background Art

Devices for determining the overall height of a vehicle on which a transport element is mounted are generally known from the prior art. A transport element can be a bicycle rack, potentially with bicycles mounted thereon, that is mounted on a vehicle roof or on the rear section, a cargo carrier, or a rooftop tent, for example. Alternatively, a transport element can also be cargo that is arranged on a trailer, such as an excavator, for example. In all the cases listed, the possibility exists or it is necessitated that the overall height of the vehicle including the transport element is increased by the transport element, and as a result there is a risk of a collision upon passage through an element that limits the clearance height. Such elements can be bridges or tunnels, for example. Otherwise, such an element can also be a garage or a garage entrance. Such a device is known from DE 10 2013 209 873 A1, for example, wherein the device has a sensor and an evaluation unit. The sensor signals are transmitted to the evaluation unit and are evaluated therein in such a manner that the overall height of the vehicle, which is to say vehicle height including the mounted transport element, is ascertained.

### SUMMARY OF THE INVENTION

It is therefore an object of the present invention to provide a device for determining the overall height of a vehicle with a transport element arranged on the vehicle that is simple in design and by means of which the overall height of the vehicle can be ascertained with high reliability and accuracy.

The device can include a sensing device that has at least one UWB sensor and a UWB tag. The UWB sensor is arranged unambiguously on the vehicle and in a generally established vehicle coordinate system. The vehicle coordinate system has an x-axis oriented in the longitudinal vehicle direction, which is to say in the direction of travel, a y-axis oriented in the transverse vehicle direction, and a z-axis oriented in the vertical vehicle direction. As a result, the x- and y-axes are oriented in the horizontal direction and the z-axis in the vertical direction. The UWB tag is arranged, in particular mounted, on the transport element, preferably on the highest point, and can be coupled to the UWB sensor. As a result, the UWB sensor and the UWB tag constitute the basic components of a generally known UWB technology, which is to say ultra-wideband technology.

The device additionally can include an evaluation unit, which is designed such that the position of the UWB tag in the vehicle coordinate system is ascertained by means of the coupling of the UWB tag to the UWB sensor and, based thereon, the overall height of the vehicle is ascertained. In this process the UWB sensor receives a signal from the UWB tag, for example, that is evaluated by the evaluation unit such that the position of the UWB tag relative to the UWB sensor is ascertained. Owing to the unambiguous arrangement of the UWB sensor in the vehicle coordinate system and the ascertained location of the UWB tag relative to the UWB sensor, the overall height or the z-position of the UWB tag in the vehicle coordinate system can be ascertained.

Owing to the determination of the overall height by means of UWB technology, which is to say owing to the use of at least one UWB sensor and a UWB tag, the overall height can be ascertained simply, reliably, and with high accuracy.

Preferably, the sensing device has solely one UWB sensor, wherein the UWB sensor and the UWB tag are arranged in alignment with one another in the z-direction. In this way, the device can be designed especially simply, since only a single UWB sensor is required owing to the aligned arrangement of the UWB tag relative to the UWB sensor. “In alignment in the z-direction” means that no displacement of the UWB tag from the UWB sensor in the x- and y-directions is present. The spacing between the UWB sensor and the UWB tag corresponds to the height difference between the UWB sensor and the UWB tag. The spacing between the UWB sensor and the UWB tag is ascertained, in particular, by a generally known TOF method, wherein the time that the signals require for transmission between the UWB tag and the UWB sensor is ascertained. Based thereon, the distance between the UWB tag and the UWB sensor is ascertained.

Alternatively, the sensing device can have multiple UWB sensors, which can be coupled to the UWB tag arranged on the transport element. The UWB sensors can be arranged at arbitrary points of the vehicle. The determination of the location of the UWB tag relative to the UWB sensors is accomplished, for example, by a so-called TDoA (Time Difference of Arrival) method, wherein the UWB sensors are synchronized to one another. When a transport element is mounted, the UWB tag sends signals at regular intervals, and the UWB sensors receive the signals within their sensing ranges and provide them with a time stamp. Subsequently, the data from the UWB sensors and the differences in the arrival times are analyzed, and the location of the UWB tag is ascertained with the aid of multilateration. Alternatively, the location of the UWB tag in the vehicle coordinate system can also be determined by other known methods.

The object of the invention is also attained by a vehicle.

The vehicle can include a device according to one of claims 1 to 5 as well as a clearance height determination device and a control unit. The clearance height determination device is designed such that an element that limits the clearance height and is located on a future route segment is detected and the permissible clearance height is ascertained. The evaluation unit is designed such that the overall height ascertained by the device and the clearance height ascertained by the clearance height determination device are compared with one another. When the ascertained overall height is greater than the ascertained clearance height, an obstacle signal is issued by the evaluation unit. The obstacle signal indicates an impending collision between the vehicle or the transport element and the element that limits the clearance height. When the ascertained clearance height is greater than the ascertained overall height of the vehicle, no obstacle signal is issued.

As a result, a collision between the vehicle and an element that limits the clearance height can be prevented in a reliable manner.

Preferably, the control unit can be coupled to a mounting sensor arranged on the transport element and/or on the vehicle in such a manner that the control unit is activated automatically when a mounted transport element is detected by the mounting sensor. Alternatively, the control unit can be activated manually by a person. As a result, the function of monitoring the vehicle height is only active when a transport element is mounted on the vehicle and, in particular, when the normal height of the vehicle is actually exceeded by a transport element.

In an example, the mounting sensor can be composed of the UWB sensor and the UWB tag in such a manner that the control unit is activated automatically as soon as the UWB tag is sensed in a sensing range of the UWB sensor. As a result, the detection of the transport element can be accomplished by means of an already existing sensor, and an additional sensor is not necessary.

Preferably, the clearance height determination device has an obstacle sensing element, a locating element, and a clearance determination module, which are arranged on the vehicle and/or on the transport element, wherein the obstacle sensing element and the locating element are connected in terms of signaling to the clearance determination module, and the clearance determination module is designed such that an element that limits the clearance height and is present on a route segment ahead of the vehicle is detected from the information from the obstacle sensing element, the element is ascertained as a function of the information from the locating element, and the clearance height of the element is ascertained on the basis of data associated with the element. The data associated with the element are, in particular, stored in a map to which the clearance determination module has access.

The clearance height determination device can have an imaging obstacle sensing element and a clearance determination module, wherein the obstacle sensing element is connected in terms of signaling to the clearance determination module, wherein the clearance determination module is designed such that an element that limits the clearance height and is present on a route segment in front of the vehicle is detected from the image, and the clearance height of the element is ascertained. In this case, other elements, such as, e.g., a preceding vehicle, with already predefined and known dimensions, are additionally sensed by the obstacle sensing element and a scaling is ascertained therefrom, wherein the scaling is used to determine the clearance height. In this way, the clearance height can be ascertained simply and reliably.

Preferably, the control unit can be connected in terms of signaling to an output device for issuing a warning to a vehicle occupant. When the comparison between the ascertained overall height and the ascertained clearance height has the result that the overall height exceeds the clearance height, a warning signal is transmitted to the output device, thus giving the driver early warning of an impending collision if driving continues.

The control unit can be connected in terms of signaling to a braking system and/or to a steering system in such a manner that a braking and/or steering intervention takes place automatically when an obstacle signal is ascertained. In this way, an impending collision can be prevented automatically and reliably.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF DRAWING

The present invention will become more fully understood from the detailed description given hereinbelow and the accompanying drawing which are given by way of illustration only, and thus, are not limitive of the present invention, and wherein the sole figure shows a vehicle with a transport element arranged thereon and having a device for determining the overall height of a vehicle and having a clearance height determination device.

### DETAILED DESCRIPTION

The figure schematically shows a side view of a vehicle 10, which in the present example is a passenger car, that is moving in the direction of travel F, which is to say in the x-direction of a vehicle coordinate system, and is approaching an element 100 that limits the clearance height HD, for example a garage entrance, a tunnel, or a bridge. The vehicle coordinate system further includes a y-direction, which extends in the transverse vehicle direction, and a z-direction, which extends in the vertical vehicle direction.

Mounted on the vehicle 10 is a roof bicycle rack 14 with a bicycle 16 attached thereto. The roof bicycle rack 14 and the bicycle 16 attached thereto together constitute a transport element 12. The transport element 12 could also be a roof box or a cargo carrier or bicycle rack device arranged on a tailgate or on the trailer hitch.

In order to avoid a collision between the vehicle 10 or the transport element 12 and the element 100 during vehicle operation, a device 20 for determining the overall height HG of the vehicle 10 with the transport element 12 mounted on the vehicle 10, a clearance height determination device 40, and a control unit 60 are provided.

The clearance height determination device 40 has an obstacle sensing element 42, a locating element 44, and a clearance determination module 46. The obstacle sensing element 42 is arranged in the front-end section, above a windshield of the vehicle 10, and serves to sense a route segment located in front of the vehicle 10. The sensing device 42 can be a camera or a radar, for example. The locating element 44 is arranged in a rear region of a vehicle roof and serves to determine the temporary position of the vehicle 10. The clearance determination module 46 is connected in terms of signaling to the obstacle sensing element 42 and the locating element 44. The clearance determination module 46 is designed such that, during vehicle operation, an element 100 that limits the clearance height HD and is present on a route segment ahead of the vehicle 10 is detected or identified from the information from the obstacle sensing element 42, the element 100 is ascertained as a function of the information from the locating element 44, and the clearance height HD of the element 100 is ascertained on the basis of data associated with the element 100. For example, an element 100 is detected by the obstacle sensing element 42, for example from an image from a camera, and, based thereon, the current position of the vehicle 10 is ascertained by means of the locating element 44. As a result of locating the vehicle 10, the element 100 can be ascertained on a map that contains the dimensions of the element 100, in particular the clearance height HD, and to which the clearance determination module 46 has access. In conclusion, the clearance height HD of the element 100 can be determined on the basis of the ascertained element 100. Alternatively, the determination of the clearance height HD could be accomplished such that the clearance height HD of the element 100 is ascertained from an image from an imaging obstacle sensing element. In this case, other elements, such as, e.g., a preceding vehicle, with already predefined and known dimensions, are additionally sensed by the obstacle sensing element 42 and a scaling is ascertained therefrom, wherein the scaling is used to determine the clearance height HD. In this case, a locating of the vehicle 10 is not necessary.

The device 20 serves to determine the overall height HG of the vehicle 10, which is to say the height including the transport element 12 mounted on the vehicle 10, in the present case the roof bicycle rack 14 with the bicycle 16 attached thereto, and includes a sensing device 22 and an evaluation unit 30.

The sensing device 22 has multiple UWB sensors 241, 242, 243 and a UWB tag 26. The UWB sensors 241, 242, 243 are arranged on the vehicle 10. The UWB tag 26 is arranged on the bicycle 16 and on the highest point of the transport element 12.

The evaluation unit 30 is connected in terms of signaling to the sensing device 22, which is to say to the UWB sensors 241, 242, 243, wherein an unambiguous location in the vehicle coordinate system, which is to say in the x-, y-, and z-directions, is associated with each of the UWB sensors 241, 242, 243. In particular the height H1 of the UWB sensors 241, 242, 243 is given by this means. The evaluation unit 30 is designed such that the location of the UWB tag 26 relative to the UWB sensors 241, 242, 243 is ascertained, for example by the so-called TDoA method. Owing to the unambiguous location of the UWB sensors 241, 242, 243 in the vehicle coordinate system, the location of the UWB tag 26 in the vehicle coordinate system is also ascertained through the ascertainment of the relative location of the UWB tag 26 with respect to the UWB sensors 241, 242, 243. In this case, the ascertained z-coordinate of the UWB tag 26 in the vehicle coordinate system corresponds to the overall height HG of the vehicle 10, since the UWB tag 26 is attached to the highest point of the transport element 12. The determination of the location of the UWB tag 26 can also be ascertained by other generally known methods.

Alternatively, the sensing device 22 could also have solely a single UWB sensor, wherein in this case the UWB tag and the UWB sensor must be arranged in alignment with one another in the z-direction.

During operation of the vehicle 10, the control unit 60 receives the information from the device 20 and the clearance height determination device 40, and carries out a comparison between the overall height HG and the clearance height HD. When the clearance height HD is greater than the overall height HG of the vehicle 10, there is no output from the control unit 60, since no collision is to be expected. When the clearance height HD is less than the overall height HG of the vehicle 10, the control unit 60 transmits an obstacle signal to a braking system 70 of the vehicle 10, which is to say to a controller of the braking system 70, and a warning signal to an output device 72. As a result of the obstacle signal, the braking system 70 is activated and an automatic braking action is triggered. The output device 72 is, for example, a display located in the passenger compartment of the vehicle 10 or a loudspeaker, wherein a warning of an impending collision in the form of a graphical representation on the display or an acoustic tone from the loudspeaker is issued to the driver, based on the warning signal.

The collision warning function is only active when a transport element 12 is actually also mounted on the vehicle 10. To this end, the UWB sensors 241, 242, 243 and the UWB tag 26 serve as a mounting sensor. As a result, the collision warning function is only active when the UWB tag 26 is located in the sensing range of the UWB sensors 241, 242, 243 and a signal exchange is present between the UWB sensors 241, 242, 243 and the UWB tag 26.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device for determining an overall height of a vehicle with a transport element arranged on the vehicle, the device comprising:
a sensing device to sense the transport element; and
an evaluator that is connected in terms of signaling to the sensing device, the evaluator being designed such that the overall height of the vehicle with the mounted transport element is ascertained from signals of the sensing device,
wherein the sensing device has at least one UWB sensor arranged unambiguously in a vehicle coordinate system and a UWB tag that is adapted to be coupled to the UWB sensor,
wherein the UWB sensor is arranged on the vehicle and the UWB tag is arranged on the transport element, and
wherein the evaluator is designed such that a position of the UWB tag in the vehicle coordinate system is ascertained via the coupling of the UWB tag to the UWB sensor and, based thereon, the overall height of the vehicle is ascertained.

2. The device according to claim 1, wherein the sensing device has solely one UWB sensor, and wherein the UWB sensor and the UWB tag are arranged in alignment with one another in the z-direction.

3. The device according to claim 1, wherein the sensing device has at least two UWB sensors that are adapted to be coupled to the UWB tag.

4. The device according to claim 1, wherein the evaluator is designed such that at least the position of the UWB tag in the z-direction is ascertained relative to the at least one UWB sensor that is arranged unambiguously at least in the z-direction in the vehicle coordinate system and, based thereon, the z-coordinate of the position of UWB tag is ascertained.

5. The device according to claim 1, wherein the UWB tag is arranged at the highest point of the transport element.

6. A vehicle comprising:
the device according to claim 1;
a clearance height determination device; and
a control unit that is designed such that the overall height ascertained by the device and the clearance height ascertained by the clearance height determination device are compared with one another and, based thereon, an obstacle signal is issued when the overall height exceeds the clearance height.

7. The vehicle according to claim 6, wherein the control unit is adapted to be coupled to a mounting sensor, which is arranged on the transport element and/or on the vehicle such that the control unit is activated automatically when a mounted transport element is detected by the mounting sensor.

8. The vehicle according to claim 7, wherein the mounting sensor comprises the UWB sensor and the UWB tag such that the control unit is activated automatically as soon as the UWB tag is sensed in a sensing range of the UWB sensor.

9. The vehicle according to claim 6, wherein the clearance height determination device comprises an obstacle sensing element, a locating element, and a clearance determination module, wherein the obstacle sensing element and the locating element are connected in terms of signaling to the clearance determination module, and the clearance determination module is designed such that an element that limits the clearance height and is present on a route segment ahead of the vehicle is detected from information from the obstacle sensing element, the element is ascertained as a function of the information from the locating element, and the clearance height of the limiting element ahead is ascertained on the basis of data associated with the element.

10. The vehicle according to claim 6, wherein the clearance height determination device has an imaging obstacle sensing element and a clearance determination module, wherein the imaging obstacle sensing element is connected in terms of signaling to the clearance determination module, wherein the clearance determination module is designed such that an element that limits the clearance height and is present on a route segment in front of the vehicle is detected from the image, and wherein the clearance height of the element is ascertained from the image.

11. The vehicle according to claim 6, wherein the control unit is connected in terms of signaling to an output device for issuing a warning to a vehicle occupant.

12. The vehicle according to claim 6, wherein the control unit is connected in terms of signaling to a braking system and/or to a steering system such that a braking and/or steering intervention takes place automatically when an obstacle signal is ascertained.
